(19) United States
(12) Patent Application Publication
(10) Pub. No.: US 2014/0290531 A1
(43) Pub. Date: Oct. 2, 2014

(54) Methods of Designing Aggregates Optimized for Specified Properties

(71) Applicants: Heinrich Jaeger, Chicago, IL (US); Marc Z. Miskin, Chicago, IL (US)

(72) Inventors: Heinrich Jaeger, Chicago, IL (US); Marc Z. Miskin, Chicago, IL (US)

(73) Assignee: The University of Chicago, Chicago, IL (US)

(21) Appl. No.: 14/239,090

(22) PCT Filed: Aug. 16, 2012
(86) PCT No.: PCT/US12/51194

§ 371 Date: Jun. 5, 2014

Related U.S. Application Data
(60) Provisional application No. 61/524,246, filed on Aug. 16, 2011.

(51) Int. Cl. G06F 19/00

(52) U.S. Cl. CPC G06F 19/701
USPC 106/400; 703/1

(57) ABSTRACT

Methods of designing an aggregate comprising a plurality of particles where the aggregate is optimized for specified properties; aggregates designed by such methods; and membranes comprising such aggregates.

### CROSS-REFERENCE TO RELATED APPLICATION

This application claims priority to U.S. Provisional Patent Application Ser. No. 61/524,246, filed Aug. 16, 2011.

### FIELD OF THE INVENTION

This invention relates to methods for designing particle shapes for use in aggregates and, more particularly, to designing particle shapes based on one or more desired aggregate properties. The invention also relates to the resulting particle shapes and to the resulting aggregates.

### BACKGROUND

Granular materials are large, random aggregates of individually solid particles that primarily interact via contact forces. This class of materials, commonly referred to as “aggregates” and subject to study in the fields of chemical engineering, mechanical engineering, soil mechanics, and physics, is among the most important for daily life and industrial applications on the planet. Common examples of aggregates include sand, gravel, soil, iron ore, fertilizer, seeds, nuts, particle, salt, powders, packaging material, and pharmaceutical pills. An aggregate may behave as a solid or as a fluid, depending on the particle type, the preparation, and the boundary conditions. Because of these characteristics, aggregates may be poured into vessels while also being structurally rigid and load-bearing when at rest.

Whether an aggregate flows like a liquid or exhibits rigidity like a solid depends on the amount of free volume available to each particle: below a certain threshold the particles cannot move past one another and the system is jammed; above that threshold there is sufficient free volume for relative movement and the system can flow. This threshold, called the “jamming transition,” is controlled by the particle packing fraction (defined as the ratio of free volume to volume occupied by the solid particles).

The location of the jamming transition and the behavior of the aggregate on the fluid and solid sides of the transition is currently known only for a very limited class of particle shapes, namely spheres, ellipsoids, cylinders or rods, and a few of the Platonic and Archimedean solids (e.g., tetrathedra). Empirical evidence demonstrates that varying the particle shape can change not only the location of the jamming transition but also other properties of a random packing.

For example, angular particle shapes result in a stiffer aggregate that is less likely to strain under an applied load than is a packing composed of spherical particles of the same material. Rod-shaped particles having a high aspect ratio of length to width do not flow as well as spheres. Slightly oblate particles pack more densely than spherical particles of the same material. Non-convex particles (e.g., particles shaped like gears or jacks) have significant concavities and can geometrically interlock. Such interlocking can provide mechanical rigidity even in the absence of any confinement of the aggregate by walls or another suitable enclosure.

### SUMMARY OF THE INVENTION

Disclosed are embodiments of aggregates; embodiments of particles; embodiments of methods of designing aggregates and particles for optimized aggregate properties; embodiments of membranes comprising such aggregates.

In various embodiments, methods of designing an aggregate are presented, comprising simulating an aggregate comprising multiple particles, each particle including at least three voxels; comparing a first parameter of the aggregate to a target parameter; iteratively changing the aggregate at least until a parameter associated with the iteratively-changed aggregate is more similar to the target parameter than it is to the first parameter.

In certain embodiments, iteratively changing the aggregate comprises changing the position of at least one voxel in each particle. In some embodiments, iteratively changing the aggregate comprises changing the number of voxels in each particle. In specific embodiments, the aggregate comprises a homogenous mixture of particles, while in other embodiments, the aggregate comprises a heterogeneous mixture of particles.

Other embodiments of disclosed methods may comprise the additional step of fabricating the aggregate.

In other embodiments, methods of designing an aggregate are presented, comprising: specifying a fitness metric, at least one parameter, and at least one stop condition; generating at least one initial guess comprising a particle including at least three voxels, where each voxel has a bearing and is in contact with at least one other voxel; simulating an aggregate comprising a plurality of the particles; calculating the fitness value using the fitness metric; mutating the particle; and repeating the simulating, calculating, and mutating steps until a winning particle is found.

In some embodiments, mutating the particle further comprises changing the bearing of at least one voxel. In certain embodiments, mutating the particle further comprises changing the number of voxels comprising the particle. Other embodiments of the disclosed methods further comprise fabricating a plurality of winning particles and combining the plurality of winning particles into an aggregate.

Still other embodiments of methods of designing an aggregate comprising a plurality of particles where the aggregate is optimized for specified properties, the method comprising: specifying a fitness metric, at least one parameter, and at least one stop condition; generating a set of initial guesses, where each guess comprises a particle comprising at least three voxels, and where each voxel has a bearing and is in contact with at least one other voxel; simulating, for each guess, an aggregate comprising a plurality of the particles; calculating, for each guess, the fitness value using the fitness metric; selecting from the set of initial guesses, a subset comprising at least one top-performing particle; generating a set of particles comprising the subset; simulating, for each particle in the set, an aggregate comprising a plurality of the particles; calculating, for each particle in the set, the fitness value using the fitness metric; selecting from the set a subset comprising at least one top-performing particle; and iterating the generating, simulating, measuring, and selecting steps until the stop condition is satisfied.

Certain embodiments of the disclosed methods further comprise: selecting from the set a subset comprising at least two top-performing particles; generating at least one blended particle comprising a blend of at least two of the selected top performing particles; and generating a set comprising the at least two top-performing particles and the at least one blended particle.

In some embodiments, the set comprising the at least two top-performing particles and the at least one blended particle further comprises a random guess comprising a particle comprising at least three voxels, where each voxel has a bearing and is in contact with at least one other voxel. In still other embodiments, the method comprises an additional step of fabricating a plurality of winning particles and combining the plurality of particles into an aggregate.

In some embodiments, an aggregate is presented whereby the aggregate is manufactured according to any of the methods in claims described above.

In certain embodiments, an aggregate is presented comprising multiple particles, each particle including three voxels, where each voxel of each particle is in contact with at least one other voxel of the same particle and each particle has substantially the same shape as the other particles in the aggregate.

In still other embodiments, an aggregate is presented comprising a plurality of first particle types and a plurality of second particle types, where the first particle type includes three voxels arranged in a first shape and the second particle type includes three voxels arranged in a second shape and the first shape is substantially non-identical to the second shape, where each voxel of each particle is in contact with at least one other voxel of the same particle.

In other embodiments, a vacuumatic is presented comprising any of the aggregates described above.

In still other embodiments, a flexible, substantially airtight membrane is presented, the membrane comprising an aggregate, the aggregate comprising multiple particles, each particle including three voxels, where each voxel of each particle is in contact with at least one other voxel of the same particle and each particle has substantially the same shape as the other particles in the aggregate, comprising: simulating an aggregate comprising multiple particles, each particle including three voxels; comparing a first parameter of the aggregate to a target parameter; iteratively changing the aggregate at least until a parameter associated with the iteratively-changed aggregate is more similar to the target parameter than is the first parameter.

The term “coupled” is defined as connected, although not necessarily directly, and not necessarily mechanically.

The terms “a” and “an” are defined as one or more unless this disclosure explicitly requires otherwise.

The term “substantially” and its variations (e.g. “approximately” and “about”) are defined as being largely but not necessarily wholly what is specified (and include wholly what is specified) as understood by one of ordinary skill in the art. In any disclosed embodiment, the terms “substantially,” “approximately,” and “about” may be substituted with “within [a percentage] of what is specified, where the percentage includes 0.1, 1.0, 5.0, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. For example, a particle that includes three voxels possesses at least three voxels, and also may possess more than three voxels.

Furthermore, a device or structure that is configured in a certain way is configured in at least that way, but may also be configured in ways that are not listed. Metric units may be derived from the English units provided by applying a conversion and rounding to the nearest millimeter.

The feature or features of one embodiment may be applied to other embodiments, even though not described or illustrated, unless expressly prohibited by this disclosure or the nature of the embodiments.

Any embodiment of any of the disclosed devices and methods can consist of or consist essentially of—rather than comprise/include/contain/have any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb.

Other features and associated advantages will become apparent with reference to the following detailed description of specific embodiments in connection with the accompanying drawings.

### BRIEF DESCRIPTION OF THE DRAWINGS

The following drawings illustrate by way of example and not limitation. For the sake of brevity and clarity, every feature of a given structure may not be labeled in every figure in which that structure appears. Identical reference numbers do not necessarily indicate an identical structure. Rather, the same reference number may be used to indicate a similar feature or a feature with similar functionality, as may non-identical reference numbers. The embodiments of the present particles shown in the figures are drawn to scale.

FIG. 1 is a schematic illustration of aggregates comprising a plurality of particles, and a particle including three voxels.

FIG. 2 is a schematic illustration of fitness metrics comprising parameters and a stop condition.

FIG. 3 illustrates embodiments of a method of generating an aggregate.

FIG. 4 is a schematic illustration of embodiments of mutations of a particle including three voxels for N iterations.

FIG. 5 illustrates embodiments of a method of generating an aggregate.

FIG. 6 illustrates a computer system adapted according to certain embodiments of a server and/or a user interface device.

FIG. 7 illustrates embodiments of a particle after 0, 30, 60, 90, and 100 iterations.

FIG. 8 is a stress-strain curve for real and simulated particles.

FIG. 9 is a plot comparing the performance of a CMA-ES algorithm, a simulated annealing algorithm, a random search algorithm.

FIGS. 10a-c are plots of function calls, relative error, and probability of success as a function of dimensionality.

FIG. 11A is a schematic illustration showing the evolution from a random guess of twenty voxels into a line.

FIG. 11B is a schematic illustration showing the evolution from six voxels into a ring.

### DETAILED DESCRIPTION

Various features and advantageous details are explained more fully with reference to the non-limiting embodiments that are illustrated in the accompanying drawings and detailed in the following description. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those of ordinary skill in the art from this disclosure.

In the following description, numerous specific details are provided to provide a thorough understanding of the disclosed embodiments. One of ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Embodiments of methods for optimizing the particle shape for a given set of constraints on the overall behavior of an aggregate are disclosed, as are examples of the resulting particles and aggregates. The composition of an aggregate will first be discussed, followed by a discussion of fitness metrics. Then, methods of creating suitable particle shapes, some of which include optimizing a particle shape to achieve or substantially achieve the fitness metric, will be discussed.

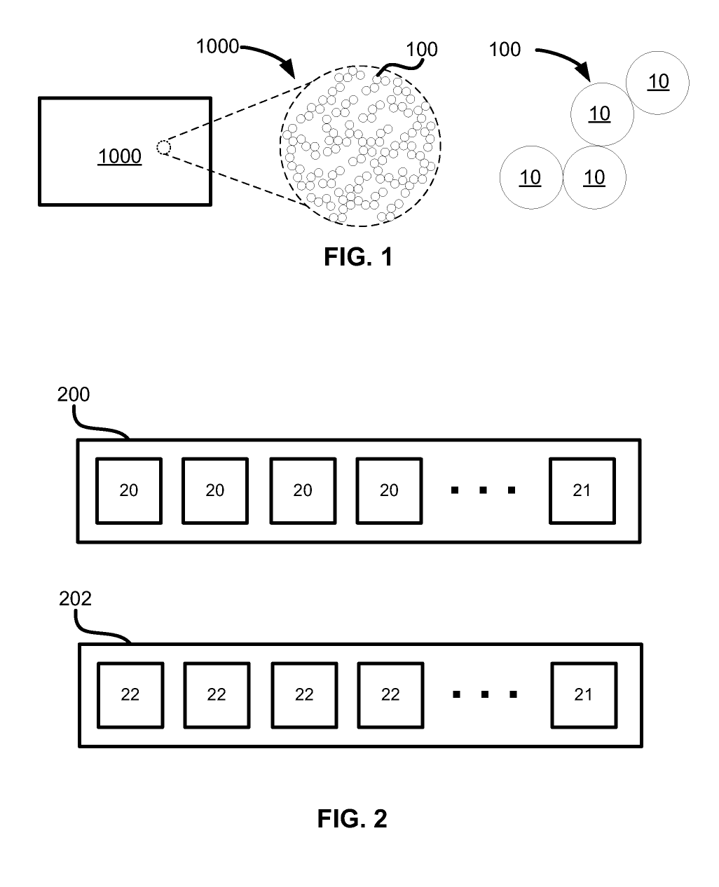

An aggregate is comprised of a plurality of particles. An aggregate must comprise enough particles to observe behavior that differs from the behavior of an individual particle. Therefore, an aggregate may comprise tens, hundreds, thousands, hundreds of thousands, or millions of particles, or even more. Soil, sand, and gravel are common examples of an aggregate. As shown in FIG. 1, aggregate 1000 is a composition of particles 100. Particles 100 in aggregate 1000 may have identical shapes in some embodiments (a homogenous aggregate) and may have different shapes in other embodiments (a heterogeneous aggregate). Each particle 100 in turn comprises a plurality of volume elements, or voxels 10. In the embodiments disclosed and discussed here, each voxel 10 in particle 100 is spherical or substantially spherical (or may take the form of a spherical structure or a substantially-spherical structure) and touches at least one adjacent voxel 10. However, in other embodiments voxels 10 may be tetrahedrons, cubes, or other arbitrary volumes. Each particle 100 comprises three or more voxels 10.

As used herein, “aggregate,” “particle,” and “voxel” may refer both to a simulated representation and a physical embodiment. A “simulated” particle is “constructed” in a simulation. A “physical” particle is “fabricated” using known fabrication techniques, such as three-dimensional printing, injection molding, casting, or other suitable techniques.

Aggregate 1000 and particles 100 have multiple material properties and performance characteristics, any one or more of which may be desirable to optimize. As shown in FIG. 2, parameter 20 may be any property or characteristic of aggregate 1000 or particle 100 that is useful in designing the shape of particle 100 or of the voxels of particle 100. In some embodiments, the total of all parameters 20 to be optimized for a given application comprise or are entered into the fitness metric 200, in such embodiments, all the desired properties of aggregate 1000 can be described by fitness metric 200, which comprises one or more parameters 20. In other embodiments, fitness metric 200 may comprise fewer than all the desired properties of aggregate 1000.

In a preferred embodiment, parameters 20 may be controlled by an optimization algorithm. To improve the rate of optimization, correlations in successful mutations are detected and those actions may then become more probable. Correlations may be detected in at least two ways. First, a deterministic function may be used to predict mutation strength and correlations between different parameters. Second, mutation strengths and correlations may be treated as parameters 20 of the representation of particle 100, and these values may be mutated as well. The deterministic function is typically faster, while folding the mutation strengths and correlations into the mutation of the particle is typically more invariant to noise.

Non-limiting examples of parameters 20 may include: the compressive strength of aggregate 1000; the density of aggregate 1000; the porosity of aggregate 1000; the packing fraction of aggregate 1000; the hardness of aggregate 1000; the toughness of aggregate 1000; the flowability of aggregate 1000; the stiffness of aggregate 1000; the shear strength of aggregate 1000; the Young's modulus of aggregate 1000; the shape of the container holding aggregate 1000; the Poisson's ratio of aggregate 1000; the volume of particle 100; the number of voxels 10 in particle 100; the rotational, reflective, or helical symmetry of particle 100; the general shape of particle 100 (e.g., line, ring, helix, etc.); the random mutations of particle 100 (e.g., a deterministic function configured to mutation strengths and correlations between different parameters or including mutation strength and correlations as part representation of particle 100); and the number of species of particle 100 (i.e., the number of non-identical types of particle in an aggregate). Parameters 20 may be specific values or ranges in some embodiments; may be set to be optimized (i.e., maximized or minimized subject to any other specified constraints) in other embodiments; or may be left unconstrained in still other embodiments.

A parameter that is optimized is not always achieved. For example, an optimized parameter may approach a target value without ever actually reaching that target value. Such a parameter may nonetheless be considered optimized.

In a preferred embodiment of the present methods, fitness metric 200 uniquely assigns a number to each particle shape 100, numerically determining its quality. In such an embodiment, fitness metric 200 is abstractly represented by any given function of parameters 20 measured in the simulation. In a preferred embodiment of the present methods, and to evolve, the value of this function is minimized.

Fitness metric 200 may range from simple to complex in various embodiments, as it comprises more parameters 20. In one embodiment, fitness metric 200 may comprise two parameters 20: for example, the particle comprises six voxels and has a ring shape. In another embodiment, fitness metric 200 may be the maximum stiffness of an aggregate in a fixed-wall container having a specified shape. In another embodiments, fitness metric 200 may comprise two conflicting parameters 20: for example, maximizing both yield stress and porosity of aggregate 1000. In still other embodiments, fitness metric 200 may comprise a mathematical function: for example, a specific stress-strain curve where stress σ is a function of strain ε.

For example, to maximize the Young's Modulus (E), fitness metric 200 is represented as:

FM=(−1)*E

To tune to a specific Young's Modulus, fitness metric 200 is represented as follows:

FM=(E_{target}−E)²

To optimize to a specific stress strain curve, fitness metric 200 can be represented as the least squares error of the obtained stress strain curve:

FM=∫(σ(ε)−[σ(ε)]_{target})²dε

Here σ is the stress and ε the strain, and the integral is covers the range of strain increments dε over which the fitness is to be optimized.

To make more general optimizations, functions of parameters 20 may be specified. For example, a function for weighted minimization of both the porosity, defined as 1−φ, where φ is the packing fraction, and Young's modulus E may be specified as:

FM=c(E−E_{target})²/E_{target}²+(1−c)(φ−φ_{target})²/φ_{target}²

where c is an number between 0 and 1 that measures the relative importance of tuning one parameter over another.

In a preferred embodiment of the present methods, it is not necessary to normalize fitness value 200.

In addition, at least one stop condition 21 is specified. Stop condition 21 may be a specified number of iterations N, a parameter value 20, or any other condition that, when satisfied, will stop the iteration process.

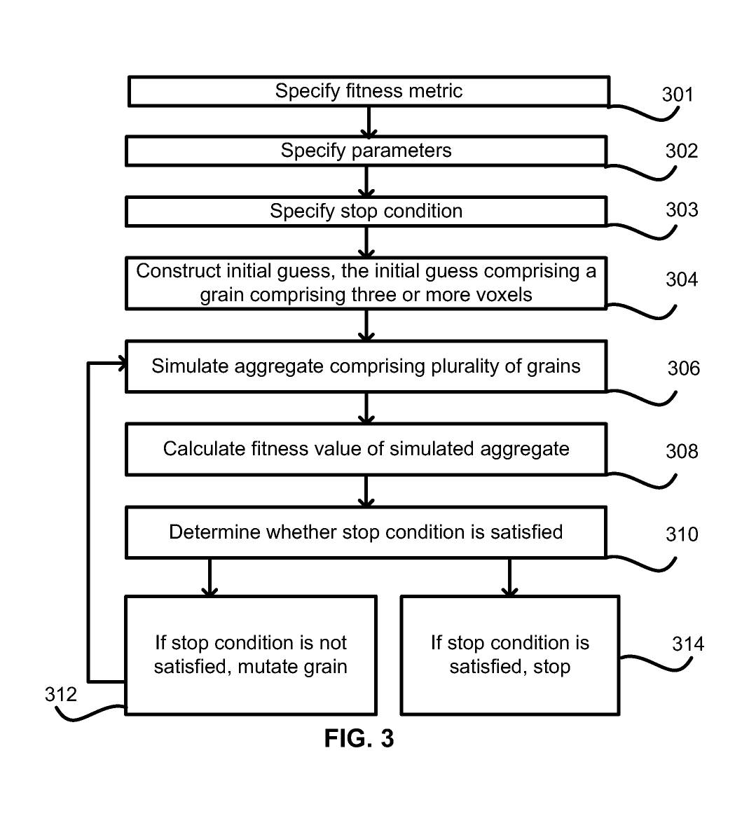

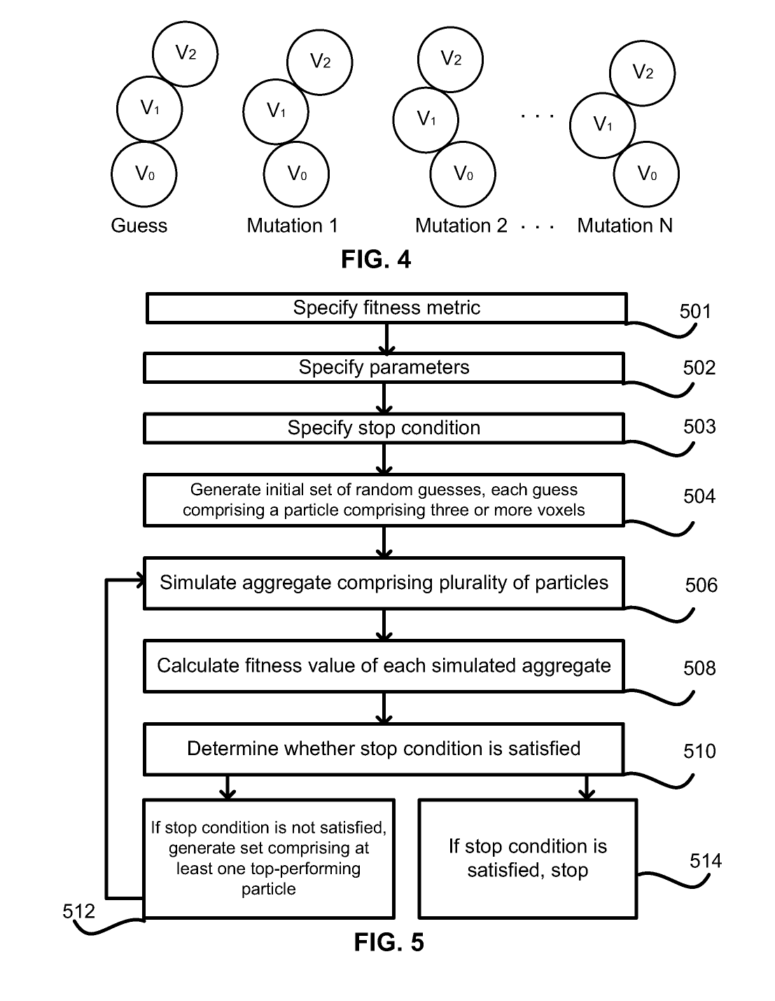

Embodiments of methods of optimizing a particle shape will now be discussed in reference to FIGS. 3 and 4. Aggregate 1000, particles 100, and voxels 10 may be represented numerically, such as in a computer simulation. Each particle 100 is constructed with at least three voxels 10. The first voxel 10 is located at the origin <0, 0, 0>. Each subsequent voxel 10 is assigned a random vector <r, θ, φ>, subject to the constraint that the voxel 10 must be in contact with at least one other voxel 10. That is, the r value of each voxel 10 is the maximum distance in the <θ, φ> direction from the origin where that voxel 10 remains in contact with at least one other voxel 10. The <θ, φ> direction is defined here as a “bearing,” and the values for <θ, φ> represent the inclination (or elevation) and azimuth, respectively. Voxels 10 with random bearing values are thus added to form a particle.

To determine the shape of a particle 100 (e.g., the ideal shape of a particle 100 that optimizes the properties of an aggregate 1000), a fitness metric 200 may be specified. A particle 100 comprising a plurality of randomly-connected voxels 10 is then constructed; this is the “guess.” An aggregate 1000 comprising particle 100 is simulated and the properties of aggregate 1000 are measured and recorded. In certain embodiments, discrete element methods or molecular dynamics methods such as PFC3D (Itasca International, Inc., Minneapolis, Minn.) may be used to simulate the stress strain curves of the aggregate 1000. Other methods or software solutions for simulating behaviors and measuring fitness values 200 of aggregate 100 comprising particles 100 may be used in other embodiments.

The fitness value 202 of the simulated aggregate is then calculated using fitness metric 200; that is, each measured parameter value 22 is inserted for the respective parameters 20 in the equation defining the fitness metric 200. If fitness value 202 satisfies stop condition 21, the optimization process stops iterating. If fitness value 202 does not satisfy stop condition 21, particle 100 is then mutated.

In preferred embodiments, stop condition(s) 21 is/are not defined in terms of a relative error or tolerance value because fitness metric 200 is configured to go to zero. In these embodiments, the closer the fitness value 202 is to zero, the “better” that grain is.

A mutation of particle 100 may comprise changing the position of voxels 10 relative to one another, adding or subtracting voxels 10 from particle 100, or a combination of both. The relative position of a voxel 10 is changed by altering its bearing <θ, φ>.

An embodiment of iterative mutation for a particle 100 comprising three voxels 10 is shown in the table below and in FIG. 4 for N mutations. In this example, the position of voxels are changed relative to one another, no voxels 10 are added to particle 100, and the build order remains the same.

| | | Mutation | Mutation | Mutation |
|---|---|---|---|---|
| Voxel | Guess | 1 | 2 | N |
| V₀ | <0, 0, 0> | <0, 0, 0> | <0, 0, 0> | <0, 0, 0> |
| V₁ | <r₀, θ₀, | <rₘₐₓ, | <rₘₐₓ, | <rₘₐₓ, |
| | φ₀>₁ | θ₁, φ₁>₁ | θ₂, φ₂>₁ | θ_{N}, φ_{N}>₁ |
| V₂ | <r₀, θ₀, | <rₘₐₓ, | <rₘₐₓ, | <rₘₐₓ, |
| | φ₀>₂ | θ₁, φ₁>₂ | θ₂, φ₂>₂ | θ_{N}, φ_{N}>₂ |

In some embodiments, the build order may be altered by mutation. For example, in the previous embodiment shown in FIG. 4, voxels 10 are built in the order of V₀, V₁, V₂. In other embodiments, the build order may be V₀, V₂, V₁. In embodiments with more than three voxels 10, voxels may be added in any order after V₀ is placed at the origin.

Once the fitness value 202 satisfies stop condition 21, the iteration process stops. The best particle 100 found in any iteration up to stop condition 21 being satisfied is termed the “winning particle.”

FIG. 5 shows other embodiments in which multiple initial guesses are used. These embodiments are similar to the embodiments of the method described above, except that rather than comprising a single initial guess, a set of multiple initial random guesses is used. For example, certain embodiments of the present methods may comprise ten random initial guesses for particle 100 and involve N iterations. After each iteration, ten aggregates 1000 each comprising one of the ten particles 100 are simulated as discussed above. A certain number of the top-performing particles (i.e., whose fitness value 202 are among smallest) are then selected as a subset of “parent particles.”

In certain embodiments, mutated “child particles” may be formed by blending the shapes of the parent particles (e.g., performing mathematical operations on the vector coordinates of the voxels 10 in each particle 100) to create a new generation of child particles. In some embodiments, the shapes of the parent particles are weighted such that the parent particle whose fitness value 202 is the best (i.e., that has the smallest value assigned by fitness metric 200) is weighted most heavily, the parent particle whose fitness value 202 is second-best is weighted second-most heavily, the parent particle whose fitness value 202 is third-best is weighted third-most heavily, and so on. In still other embodiments, the top-performing parent particles are weighted randomly.

In other embodiments, the top-performing particles are placed in a new set comprising the top-performing particles, mutations of the top performing particles, and/or additional guesses. For example, out of an original set of ten random guesses, a subset of three top-performing particles may be selected. A new set of ten particles may be generated comprising the subset of the three top-performing particles, a mutation of each top-performing particle, and four additional random guesses. Of course in other embodiments, the set may be larger or smaller, may include more or fewer mutations of the top-performing particles, and may comprise more or fewer additional random guesses.

In still other embodiments, the top-performing particles 100 may be made to form a heterogeneous aggregate comprising different species of particles. In such embodiments, the number of species of a particle may be an unconstrained parameter 20 of fitness metric 200, or may be any range of natural numbers. In such embodiments, each species of particle may be mutated in parallel, that is, each species of particle is not blended or mixed with another parent particle. In other embodiments, each species is not mutated in parallel. After each mutation, aggregate 1000 comprising the different species of particle may be simulated, and the fitness value 202 assigned to the mixture via fitness metric 200. In such embodiments, the ratio of particle species may be manipulated as part of the mutation process (e.g., 50% first species, 30% second species, and 20% third species).

In certain embodiments, it may be desired to compare the properties of the simulated aggregate comprising simulated particles with those of a physical aggregate comprising physical particles. In these embodiments, a plurality of particles identified as having the lowest fitness values 202 after stop condition 21 is satisfied are fabricated using known techniques. For example, particles may be fabricated using three-dimensional printers, injection molding, casting, laser sintering, or other techniques. The physical aggregate comprising these particles may then be subjected to the same tests and evaluated on the same parameters as in the simulation. Non-limiting examples of such tests include triaxial tests; three point bend tests; Brazilian tests; tension tests; shear rheometry tests; angle of repose tests; packing density measurements; flowability tests; failure tests; impact tests; shock absorption tests; penetrometer tests; compression-relaxation tests; filtration tests; and erosion tests.

The fabricated particles may comprise any suitable metal, polymer, ceramic, and/or glass. Non-limiting examples of materials from which particles may be fabricated include: polymers such as nylon, polystyrene, acrylonitrile butadiene styrene (ABS) polymer, polycarbonates, polycaprolactone, polyphenylsulfones, Ultem resins (SABIC Innovative Plastics, One Plastics Ave. Pittsfield, Mass. 01201) and waxes; metals such as steel alloys, titanium alloys, and other suitable alloys; and composites and green sand.

Vacuumatically prestressed structures (or “vacuumatics”) may be formed using as filler elements aggregates created according to methods disclosed herein. Vacuumatics rely on the structural principle of prestressing aggregates inside a flexible, substantially airtight membrane by introducing a partial vacuum inside this enclosure. The atmospheric pressure acting on the membrane causes the skin to be tightly wrapped around the surface of the aggregate, freezing the configuration of the filler. Rigid load-bearing structures can be created this way.

Vacuumatics are adaptable and flexible in form. Without minimal negative pressure (˜0% vacuum), the filler inside the membrane may flow freely within it. Increasing the amount of vacuum pressure reduces the ability of the filler to flow within the membrane, eventually resulting in a substantially plastic behavior of the structure. This enables the structure to be shaped while keeping its newly given form. Finally, in substantially deflated state (˜100% vacuum) the vacuumatic structure becomes rigid, largely depending on the exact properties of the aggregate used as filler. See Huijben, F., Herwijnen, F. van, Lindner, G (2007), “Vacuumatic pre-stressed flexible architectural structures”, III International Conference on Textile Composites and Inflatable Structures, Structural Membranes 2007, Barcelona (ESP), p. 197-200; Huijben, F., Herwijnen, F. van (2007), “Vacuumatics; shaping space by ‘freezing’ the geometry of structures”, International Conference on Tectonics, Tectonics: Making Meaning 2007, Eindhoven University of Technology, Eindhoven (NLD); Huijben, F., Herwijnen, F. van (2008), “Vacuumatics: vacuumatically prestressed (adaptable) structures”, 6th International Conference on Computation of Shell & Spatial Structures, IASS-IACM 2008: Spanning Nano to Mega, Ithaca N.Y. (USA).

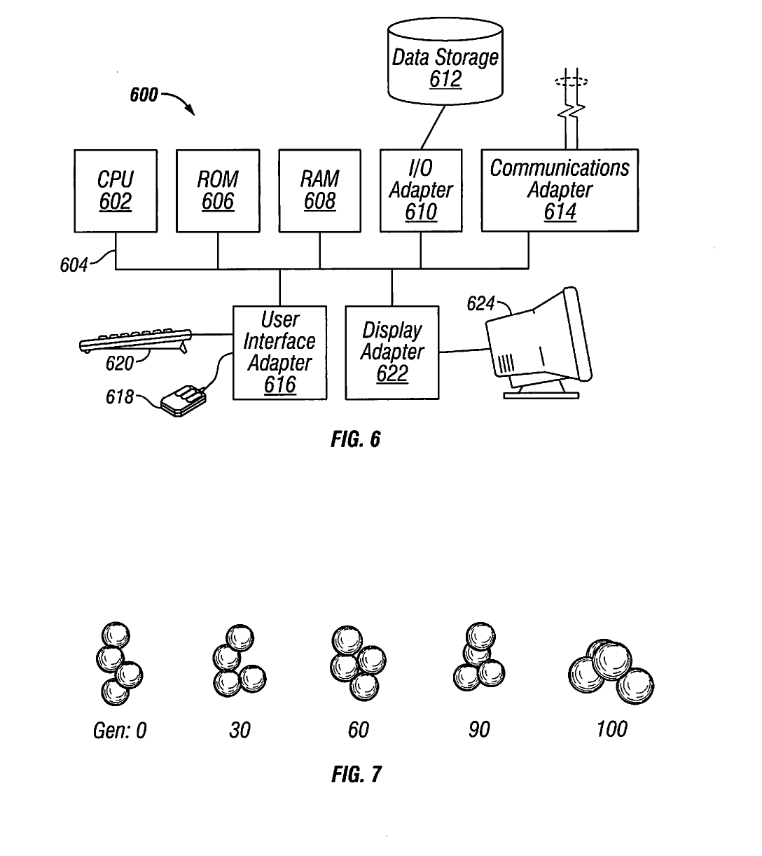

Embodiments of the present methods can be performed using a computer system. FIG. 6 illustrates a computer system 600 adapted according to certain embodiments of a server and/or a user interface device. Central processing unit (CPU) 602 is coupled to the system bus 604. CPU may be a general-purpose CPU or microprocessor. The present embodiments are not restricted by the architecture of CPU 602, so long as CPU 602 supports the operations described herein. CPU 602 may execute various logical instructions consistent with embodiments of the present methods. For example, CPU 602 may execute machine-level instructions according to the exemplary operations described above with reference to FIG. 3 or FIG. 5.

Computer system 600 also may include Random Access Memory (RAM) 608, which may be SRAM, DRAM, SDRAM, or the like. Computer system 600 may utilize RAM 608 to store the various data structures used by a software application configured to design aggregates or simulate aggregate behavior, as discussed in reference to FIGS. 1-5 above. Computer system 600 may also include Read Only Memory (ROM) 606 which may be PROM, EPROM, EEPROM, optical storage, or the like. ROM 606 may store configuration information for booting computer system 600. RAM 608 and ROM 606 hold user and system 100 data.

Computer system 600 may also include an input/output (I/O) adapter 610, a communications adapter 614, a user interface adapter 616, and a display adapter 622. I/O adapter 610 and/or user interface adapter 616 may, in certain embodiments, enable a user to interact with computer system 600 in order to input information for fitness metric 200 and/or parameters 20 and/or stop condition 21. In a further embodiment, display adapter 622 may display a graphical user interface associated with a software or web-based application for a method of designing an aggregate.

I/O adapter 610 may connect to one or more storage devices 612, such as one or more of a hard drive, a Compact Disk (CD) drive, a floppy disk drive, a tape drive, to the computer system 600. Communications adapter 614 may be adapted to couple the computer system 600 to the network 106, which may be one or more of a LAN and/or WAN, and/or the Internet. User interface adapter 616 couples user input devices, such as a keyboard 620 and a pointing device 618, to computer system 600. Display adapter 622 may be driven by CPU 602 to control the display on display device 624.

The present embodiments are not limited to the architecture of system 600. Rather computer system 600 is provided as an example of one type of computing device that may be adapted to perform the functions of a server and/or a user interface device. For example, any suitable processor-based device may be utilized including without limitation, including personal data assistants (PDAs), mobile phones, computer game consoles, multi-processor servers, and graphics processing units (GPUs). Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

In addition, some embodiments of the present devices comprise computer readable media having machine readable instructions that, when executed by a computer or computer system, will cause the performance of embodiments of the methods disclosed herein. Such embodiments may also be characterized as computer readable media having (or encoded with) machine readable instructions for performing certain step(s) (e.g., any one or more of the steps of one or more of the present methods). The computer readable media may be any suitable form of memory or data storage device, including but not limited to hard drive media, optical media, EPROM, EEPROM, tape media, cartridge media, flash memory, ROM, memory stick, and/or the like. Computer readable media includes any physical medium that can store or transfer information. Should it be necessary, computer readable media can be generically represented in a figure as a box that the machine readable instructions it includes may be represented as a smaller box within the computer readable media box. The term “computer readable media” does not include wireless transmission media, such as carrier waves, though other embodiments of the present invention may comprise carrier waves that include machine readable instructions for performing certain step(s) (e.g., any one or more of the steps of one or more of the present methods). The software stored on the computer readable media can be written according to any technique known in the art. For instance, the software may be written in any one or more computer languages (e.g., ASSEMBLY, PASCAL, FORTRAN, BASIC, C, C++, C#, JAVA, etc.). The code may be written to enable it to be compiled on all common platforms (e.g., Microsoft®, Linux®, Apple Macintosh® OS X, Unix®).

Some embodiments of the present methods include converting data representing parameters 20 and/or fitness metric 200 into digital electrical signals that can then be processed in order to carry out other steps in the respective method. Some embodiments of the present methods may be performed within a certain amount of time, such as an amount of time less than what it would take to perform the method without the use of a computer system, including no more than one hour, no more than 30 minutes, no more than 15 minutes, no more than 10 minutes, and no more than one minute.

### FIRST EXPERIMENTAL EXAMPLE

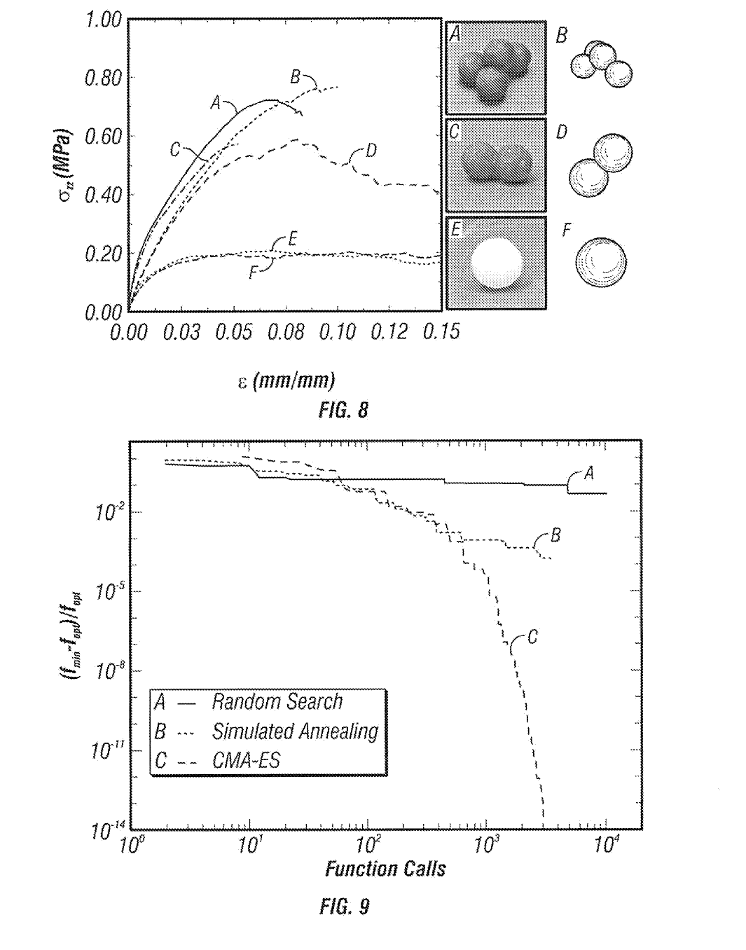

One specific example of embodiments of the method will be discussed. As shown in FIGS. 7 and 8, it was desired to build a tough, strong aggregate comprising a single species of particle comprising four voxels. First, the stop condition 21 of one hundred iterations and simulation parameters 20 were set:

| | |
|---|---|
| Iterations: | 100 |
| Species: | 1 |
| Voxels: | 4 |

The fitness metric 200 was defined by the stress and strain evaluated at the strain halfway between the start of the test and the maximum stress value:

FM=−(Stress(Half-Max)−Stress(Initial))/Strain(Half-Max)

A first guess particle 100 was constructed from four voxels 10. An aggregate 1000 comprising the first guess particle was simulated, and the fitness value 202 determined. The particle 100 was then mutated for the specified one-hundred iterations

After running for the specified one-hundred iterations, as shown in FIG. 8, stop condition 21 was satisfied and the process stopped. Using a three-dimensional printer, an aggregate 1000 comprising the winning particle 100 was fabricated. The measured stress-strain curve for the winning particle 100 was compared to the simulated behavior, as shown in FIG. 8. Also shown in this figure are the simulated and measured stress-strain curves for a two-voxel particle and a one-voxel spherical particle.

### SECOND EXPERIMENTAL EXAMPLE

A second experimental example will now be discussed. As shown in FIGS. 9-12B, an algorithm was used to evolve shapes with known geometric properties. Specifically, the ability of the algorithm to build different topologies and identify families of shapes was tested. In addition, the ability of these features to scale well with the number of elements involved in the search problem was tested.

Evolution strategies (ES) were used as the primary optimizer due to their emphasis on direct manipulation of real-valued parameters through mutation. Specifically, the Covariance Matrix Adaptation Evolution Strategy or CMA-ES developed by Hansen et al., was used, modified to use rank-μ update only. Like most evolution strategies, this algorithm attempts to improve the quality of solutions by examining random perturbations around a given mean solution. The CMA-ES performs draws these guesses using a multivariate Gaussian distribution. The key feature of this algorithm is that it uses information from prior guesses in the evolution to deterministically update the mean and covariance matrix. Specifically, the mean of the distribution is updated so that the likelihood of drawing a previously found good candidate is maximized whereas the covariance matrix is updated so as to increase the probability of a successful step.

A modification to the fitness metric was included to improve the overall performance of the algorithm, arising from the fact that the search domain is periodic.

Consequently, there are an infinite number of degenerate solutions to a given optimization problem spread out over all of search space. In order to prevent searches from wasting function calls exploring this degeneracy, we included a small multiplicative factor to the fitness values. It rescales the fitness value to increase quadratically if the maximum absolute value of an angle in a blueprint is over π. In that way, the search space is softly bounded and prevented from investigating redundant angles.

In comparing the tested algorithm to other search methods, we found that the CMA-ES outperformed alternatives by requiring significantly fewer function calls to identify a solution. For instance, consider FIG. 9, which compares the performance of the CMA-ES to a simulated annealing algorithm and a random search algorithm. Here, all three algorithms are being used to construct tetrahedrons by minimizing the sum of the distances to the center of mass for four voxels. The relative difference between the best solution found and the global optimum is plotted against the number of iterations required. After about five hundred function calls, the CMA-ES begins to dramatically outperform simulated annealing. Since each generation typically uses about eight function calls, this corresponds to just over fifty generations.

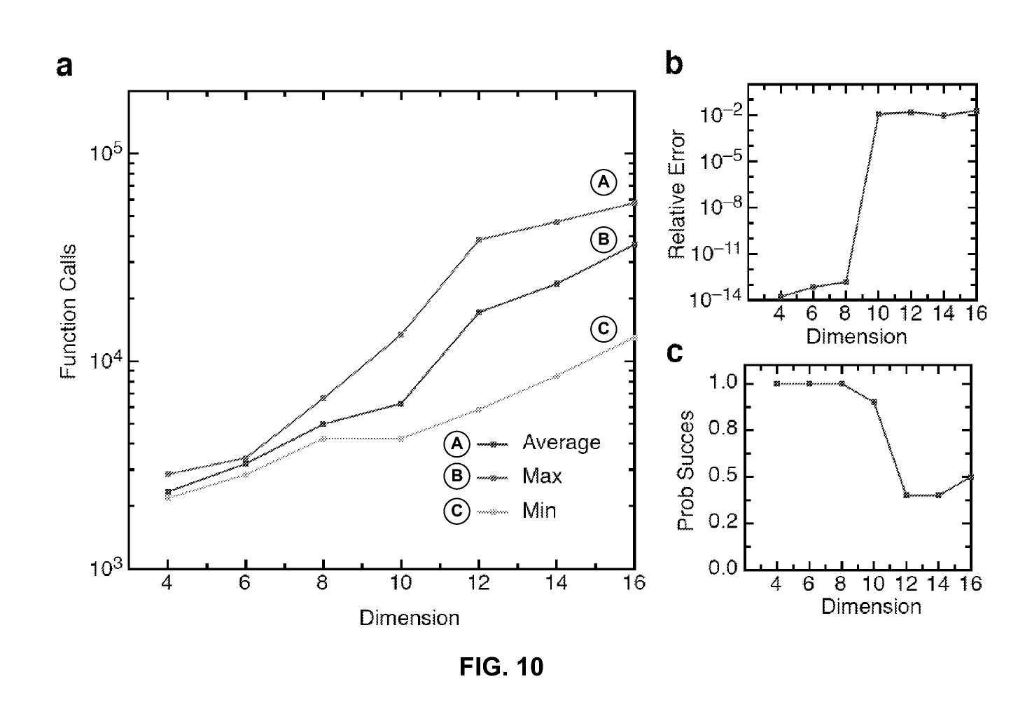

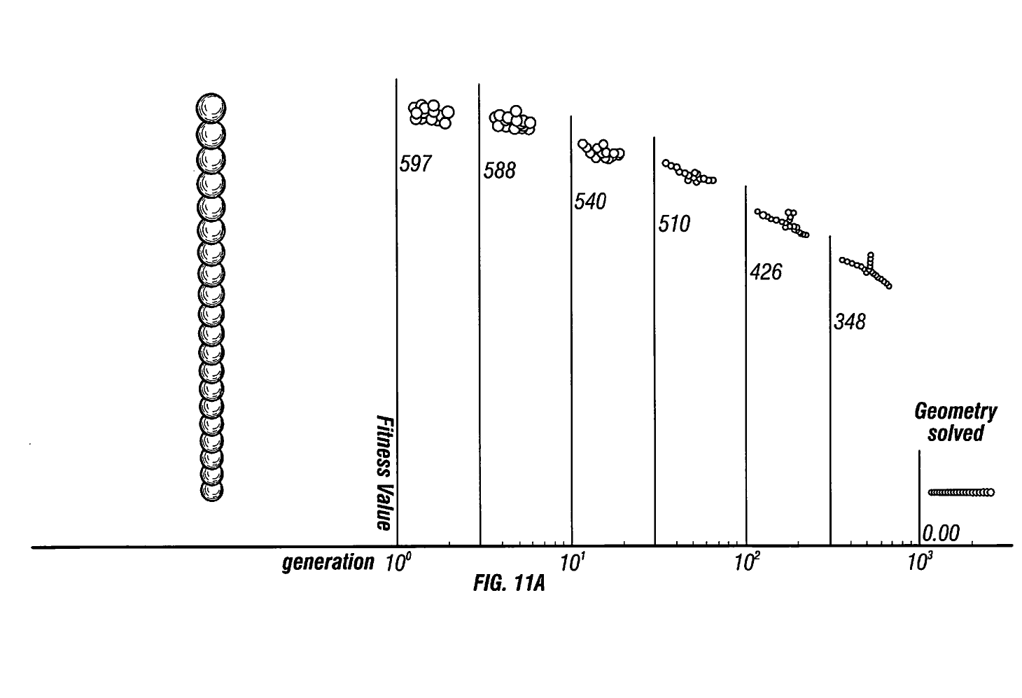

The task of minimizing the sum of the distances to the center of mass also provides a good benchmark to study how the algorithm scales in a very complex search space. For objects made with fewer than thirteen voxels, the correct solutions are deltahedra, i.e. polyhedra with triangular faces. The problem becomes remarkably challenging since the number of local minima increases very rapidly with the number of voxels. The tested algorithm was always able to find the exact same solution, between three and five voxels (FIG. 10c). The algorithm was forced to find solutions with relative errors as low as 10⁻¹⁵ (FIG. 10b), and so the number of generations for convergence was typically between four hundred and five hundred (FIG. 10a). However, a solution within a percent or less of the global optimum is usually obtained within the first one hundred generations.

When the dimensionality of the search space is increased to exceed ten, i.e., the number of voxels reaches seven or more, the global algorithm performance decreases and the probability of finding the global optimum declines from 1.0 to ˜0.5 (FIG. 10c). In practice, however, this degradation is not a major hurdle. First, the solutions obtained are possess relative errors of ˜10-2. Second, in this case, the decline does not appear as a trend for larger dimensions, but rather saturates around 0.5. That said the effect can be almost completely mitigated by simply running the optimization from fresh starting configurations.

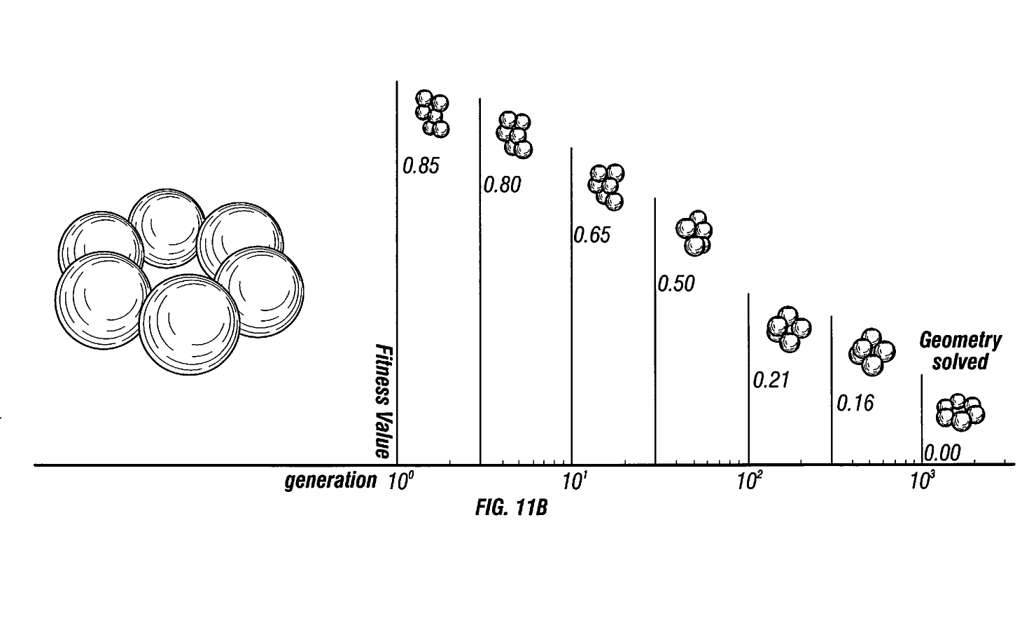

It was observed that this degradation in performance is not a general feature of the algorithm, but instead specific to a problem. For instance, if the fitness metric is changed to maximize the sum of the distances to the center of mass, the algorithm always converges to lines even when the number of building blocks is as high as 20 voxels (dimension ˜40) (FIG. 11A).

Since the CMA-ES is largely a local search algorithm, it is natural that its global performance declines when the search space is overly rugged in a high dimension. It is known that if the number of trials needed to adjust the covariance matrix effectively becomes larger than the number of trials needed to locate an optimum, the global performance can begin to decline. For such situations, global versions of the CMA-ES exist that capitalize on the restart concept and are often extremely successful.

Finally, to verify that the algorithm can explore different topologies, the code was used to construct rings from five voxels. Again, the code is able to adapt a jumbled mess to a ring in roughly one thousand generations (FIG. 11B). Ultimately, compact polyhedra, lines and rings are all equally accessible in the chosen building representation and can be discovered easily by the chosen algorithm.

It should be understood that the present devices and methods are not intended to be limited to the particular forms disclosed. Rather, they are to cover all modifications, equivalents, and alternatives falling within the scope of the claims.

The claims are not to be interpreted as including means-plus- or step-plus-function limitations, unless such a limitation is explicitly recited in a given claim using the phrase(s) “means for” or “step for,” respectively.

1. A method of fabricating an aggregate, comprising:
simulating an aggregate comprising multiple simulated particles, each simulated particle including at least three voxels;
comparing a first parameter of the simulated aggregate to a target parameter;
iteratively changing the simulated aggregate at least until a parameter associated with the iteratively-changed simulated aggregate is more similar to the target parameter than it is to the first parameter; and
fabricating the aggregate.

2. The method of claim 1, where iteratively changing the simulated aggregate comprises changing the position of at least one voxel in each particle.

3. The method of claim 1, where iteratively changing the simulated aggregate comprises changing the number of voxels in each particle.

4. The method of claim 1, where the fabricated aggregate comprises a homogenous mixture of particles.

5. The method of claim 1, where the fabricated aggregate comprises a heterogeneous mixture of particles.

6. (canceled)

7. A method of fabricating an aggregate, comprising:
specifying a fitness metric, at least one parameter, and at least one stop condition;
generating at least one initial guess comprising a simulated particle including at least three voxels, where each voxel has a bearing and is in contact with at least one other voxel;
simulating an aggregate comprising a plurality of the particles;
calculating the fitness value using the fitness metric;
mutating the simulated particle;
repeating the simulating, calculating, and mutating steps until a winning simulated particle is found; and
fabricating a plurality of particles in the design of the winning simulated particle and combining them into an aggregate.

8. The method of claim 7, where mutating the simulated particle further comprises changing the bearing of at least one voxel.

9. The method of claim 7, where mutating the simulated particle further comprises changing the number of voxels comprising the particle.

10. (canceled)

11. A method of fabricating an aggregate comprising a plurality of particles where the aggregate is optimized for specified properties, the method comprising:
specifying a fitness metric, at least one parameter, and at least one stop condition;
generating a set of initial guesses, where each guess comprises a simulated particle comprising at least three voxels, and where each voxel has a bearing and is in contact with at least one other voxel;
simulating, for each guess, an aggregate comprising a plurality of the simulated particles;
calculating, for each guess, the fitness value using the fitness metric;
selecting from the set of initial guesses, a subset comprising at least one top-performing simulated particle;
generating a set of particles comprising the subset;
simulating, for each particle in the set, an aggregate comprising a plurality of the simulated particles;
calculating, for each simulated particle in the set, the fitness value using the fitness metric;
selecting from the set a subset comprising at least one top-performing simulated particle;
iterating the generating, simulating, measuring, and selecting steps until the stop condition is satisfied; and
fabricating a plurality of particles in the shape of at least one of the top-performing simulated particles and combining the plurality of fabricated particles into an aggregate.

12. The method of claim 11, further comprising:
selecting from the set a subset comprising at least two top-performing simulated particles;
generating at least one blended simulated particle comprising a blend of at least two of the selected top performing simulated particles; and
generating a set comprising the at least two top-performing simulated particles and the at least one blended simulated particle.

13. The method of claim 12, where the set comprising the at least two top-performing simulated particles and the at least one blended simulated particle further comprises a random guess comprising a simulated particle comprising at least three voxels, where each voxel has a bearing and is in contact with at least one other voxel.

14.-19. (canceled)

20. An aggregate according to claim 1.

21. An aggregate according to claim 7.

22. An aggregate according to claim 11.

23. An aggregate according to claim 11, wherein at least one particle in the aggregate is comprised of metal, polymer, ceramic or glass.
